(19) United States
(12) Patent Application Publication
(10) Pub. No.: US 2025/0335792 A1
(43) Pub. Date: Oct. 30, 2025

(54) KNOWLEDGE BASE UPDATING METHOD, ELECTRONIC DEVICE, AND STORAGE MEDIUM

(71) Applicant: Lenovo (Beijing) Limited, Beijing (CN)

(72) Inventors: Xinbin LIU, Beijing (CN); Cong LI, Beijing (CN); Jun PAN, Beijing (CN)

(21) Appl. No.: 19/194,072

(22) Filed: Apr. 30, 2025

(30) Foreign Application Priority Data
Apr. 30, 2024 (CN) 202410544373.9

(51) Int. Cl. G06N 5/022; G06F 16/906; G06F 16/93

(52) U.S. Cl. CPC G06N 5/022; G06F 16/906; G06F 16/93

(57) ABSTRACT

A knowledge base updating method includes: obtaining a plurality of question messages processed by a task processing model without relying on a knowledge base and a plurality of satisfaction results corresponding to the plurality of question messages; determining at least one target document in the knowledge base matching a question message of the plurality of question messages; based on a satisfaction result of the plurality of satisfaction results corresponding to each question message of at least one question message of the plurality of question messages associated with a target document of the at least one target document, determining a comprehensive satisfaction degree of the user with at least one feedback message corresponding to the at least one question message associated with the target document; and when the comprehensive satisfaction degree corresponding to the target document exceeds a set threshold, compressing the target document.

### CROSS-REFERENCE TO RELATED APPLICATION

The present disclosure claims priority of Chinese Patent Application No. 202410544373.9, filed on Apr. 30, 2024, the entire content of which is hereby incorporated by reference.

### FIELD OF THE DISCLOSURE

The present disclosure generally relates to the field of artificial intelligence technology and, more particularly, relates to a knowledge base updating method and a knowledge base updating device.

### BACKGROUND

With continuous development of artificial intelligence technology, various task processing models such as large language models may use knowledge bases to accurately determine feedback messages corresponding to question messages input by users.

However, when the amount of knowledge in a knowledge base is large, in a process of processing question messages with help of a task processing model, much memory resources may be consumed. As such, situations may be encountered, where feedback messages may not be effectively determined due to insufficient memory resources of the electronic device deployed with the task processing model.

### SUMMARY

One aspect of the present disclosure provides a knowledge base updating method. The method includes obtaining a plurality of question messages processed by a task processing model without relying on a knowledge base and a plurality of satisfaction results corresponding to the plurality of question messages. A satisfaction result of the plurality of satisfaction results corresponding to a question message of the plurality of question messages indicates a satisfaction degree of a user with a feedback message output by the task processing model in processing the question message. The method also includes determining at least one target document in the knowledge base matching a question message of the plurality of question messages; based on a satisfaction result of the plurality of satisfaction results corresponding to each question message of at least one question message of the plurality of question messages associated with a target document of the at least one target document, determining a comprehensive satisfaction degree of the user with at least one feedback message corresponding to the at least one question message associated with the target document; and when the comprehensive satisfaction degree corresponding to the target document exceeds a set threshold, compressing the target document.

Another aspect of the present disclosure provides an electronic device. The electronic device includes one or more processors and a memory containing a computer program that, when being executed, causes the one or more processors to perform: obtaining a plurality of question messages processed by a task processing model without relying on a knowledge base and a plurality of satisfaction results corresponding to the plurality of question messages, where a satisfaction result of the plurality of satisfaction results corresponding to a question message of the plurality of question messages indicates a satisfaction degree of a user with a feedback message output by the task processing model in processing the question message; determining at least one target document in the knowledge base matching a question message of the plurality of question messages; based on a satisfaction result of the plurality of satisfaction results corresponding to each question message of at least one question message of the plurality of question messages associated with a target document of the at least one target document, determining a comprehensive satisfaction degree of the user with at least one feedback message corresponding to the at least one question message associated with the target document; and when the comprehensive satisfaction degree corresponding to the target document exceeds a set threshold, compressing the target document.

Another aspect of the present disclosure provides a non-transitory computer readable storage medium containing a computer program that, when being executed, causes at least one processor to perform: obtaining a plurality of question messages processed by a task processing model without relying on a knowledge base and a plurality of satisfaction results corresponding to the plurality of question messages, where a satisfaction result of the plurality of satisfaction results corresponding to a question message of the plurality of question messages indicates a satisfaction degree of a user with a feedback message output by the task processing model in processing the question message; determining at least one target document in the knowledge base matching a question message of the plurality of question messages; based on a satisfaction result of the plurality of satisfaction results corresponding to each question message of at least one question message of the plurality of question messages associated with a target document of the at least one target document, determining a comprehensive satisfaction degree of the user with at least one feedback message corresponding to the at least one question message associated with the target document; and when the comprehensive satisfaction degree corresponding to the target document exceeds a set threshold, compressing the target document.

Other aspects of the present disclosure may be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flow chart of a knowledge base updating method consistent with the disclosed embodiments of the present disclosure;

FIG. 2 illustrates another flow chart of a knowledge base updating method consistent with the disclosed embodiments of the present disclosure;

FIG. 3 illustrates a schematic framework of an implementation principle of a knowledge base updating method consistent with the disclosed embodiments of the present disclosure;

FIG. 4 illustrates another flow chart of a knowledge base updating method consistent with the disclosed embodiments of the present disclosure;

FIG. 5 illustrates an implementation flowchart of controlling a document fragment to be added to a knowledge base, consistent with the disclosed embodiments of the present disclosure;

FIG. 6 illustrates a schematic framework of an implementation principle for controlling a document fragment to be added to a knowledge base, consistent with the disclosed embodiments of the present disclosure;

FIG. 7 illustrates a schematic composition structural diagram of a knowledge base updating device consistent with the disclosed embodiments of the present disclosure; and

FIG. 8 illustrates a schematic composition structural diagram of an electronic device consistent with the disclosed embodiments of the present disclosure.

### DETAILED DESCRIPTION

To make the objectives, technical solutions and advantages of the present disclosure more clear and explicit, the present disclosure is described in further detail with accompanying drawings and embodiments. It should be understood that the specific exemplary embodiments described herein are only for explaining the present disclosure and are not intended to limit the present disclosure.

It should be noted that in the present disclosure, relational terms such as “first” and “second” are only configured to distinguish one entity or operation from another entity or operation, and do not necessarily require or imply that such actual relationship or sequence exists between these entities or operations. Terms “comprise”, “include” or any other variations thereof are intended to cover a non-exclusive inclusion. A process, method, article, or apparatus that includes a series of elements includes not only the series of elements, but also other elements not expressly listed, or elements inherent to such a process, method, article, or apparatus. Without further limitation, an element defined by a statement like “comprises a . . . ” does not exclude the presence of additional identical elements in a process, method, article, or apparatus that includes the foregoing element.

It should be noted that relative arrangements of components and operations, numerical expressions and numerical values set forth in exemplary embodiments are for illustration purposes only and are not intended to limit the present disclosure unless otherwise specified. Techniques, methods and apparatus known to the skilled in the relevant art may not be discussed in detail, but these techniques, methods and apparatus should be considered as a part of the specification, where appropriate.

The present disclosure provides a knowledge base updating method. FIG. 1 illustrates a flow chart of a knowledge base updating method consistent with the disclosed embodiments of the present disclosure. The knowledge base updating method may be applied to any electronic device, and is particularly suitable for electronic devices with limited memory or other hardware resources, such as mobile phones, laptops, or desktop computers. As shown in FIG. 1, the knowledge base updating method may include S101, S102, S103 and S104.

S101: obtaining a plurality of question messages processed by a task processing model without relying on a knowledge base, and satisfaction results corresponding to the plurality of question messages.

In the present disclosure, the task processing model may be a machine learning model, configured to output a feedback message based on the question message provided by a user. For example, the task processing model may be a large language model. A user may input question messages such as information query requests, dialogue sentences, or task instructions into the large language model. The large language model may provide feedback messages such as query results, reply statements or task execution results based on the question messages entered by the user. The task processing model may also be other large-scale machine learning models. The present disclosure does not limit a specific type of task processing mode.

The knowledge base may be stored with a large amount of knowledge objects that the task processing model needs to query or refer to when processing question messages. In the present disclosure, the knowledge object in the knowledge base may at least represent a document fragment segmented from a document. Based on the information contained in the document fragments represented by each knowledge object in the knowledge base, the task processing module is may provide relevant knowledge basis for analyzing and processing question messages.

The satisfaction result corresponding to the question message may be used to indicates the satisfaction degree of the user with the feedback message output by the task processing model in processing the question message. For example, a satisfaction result may indicate whether the feedback message output by the task processing model in processing the question messages is satisfactory. Accordingly, the satisfaction result may be satisfactory or unsatisfactory.

For example, the satisfaction result may be the user's satisfaction level or satisfaction grade with the feedback message output by the task processing model in processing the question messages. The satisfaction level may be classified as very satisfied, relatively satisfied, average, and dissatisfied. The satisfaction grade may be a satisfaction score, which may be classified as 100 points, 80 points, 60 points, and scores below 60 points. Alternatively, the satisfaction grade may be a degree of satisfaction expressed in percentage. For example, the satisfaction grade may be classified as 100% satisfaction, 80% satisfaction, 60% satisfaction, and 20% satisfaction. The present disclosure does not limit a specific expression of satisfaction result.

It may be understood that the plurality of question messages is question messages historically input to the task processing model, and processed by the task processing model without relying on a knowledge base.

In order not to affect the normal processing of the task processing model for each question message input by a user, in the present disclosure, the plurality of question messages obtained may be a plurality of question messages historically input by the user and selected for testing. The question messages selected for testing refer to the question messages used to test the validity of the documents in the knowledge base.

S102: for each question message, determining at least one target document in the knowledge base that matches the question message.

The target document matches the question message, indicating that in the document fragments segmented from the target document, there is at least one candidate knowledge object of the candidate document fragment that matches the question message. In the present disclosure, for sake of distinction, the document matching the question message is referred to as the target document.

The knowledge base may include a plurality of knowledge objects. The document fragments represented by the knowledge objects are derived from documents. As such, the knowledge base updating method may determine at least one target document, to which each candidate knowledge object matching the question message belongs, in the knowledge base. The candidate knowledge object matches the question information when the similarity between the candidate knowledge object and the question information exceeds a set similarity threshold.

It should be noted that the target document in the knowledge base matching the question message may be matched and determined from the knowledge base in real time when the knowledge base needs to be updated. Alternatively, after obtaining a question message, at least one target document matching the question message may be determined first, and the document information (such as the document name or other document identifier, etc.) of the at least one target document matching the question message may be stored. On this basis, the knowledge base updating method may directly determine the target document corresponding to the question message based on the matching relationship between different stored question messages and the target documents.

S103: for each target document, based on the satisfaction result corresponding to each question message associated with the target document, determining the comprehensive satisfaction degree of the user with respect to the feedback message corresponding to the at least one question message associated with the target document. The comprehensive satisfaction degree reflects the user's overall satisfaction with the feedback messages output by the task processing model in processing the at least one question message associated with the target document.

In the present disclosure, for each target document, the comprehensive satisfaction degree may be a satisfaction result determined by comprehensively analyzing the satisfaction result corresponding to each of the question messages associated with the target document. The comprehensive satisfaction degree may also be a satisfaction result determined by comprehensively analyzing the satisfaction results corresponding to part of the question messages associated with the comprehensive target document. The present disclosure does not limit whether the comprehensive satisfaction result is determined by comprehensively analyzing the satisfaction result corresponding to each or part of the question messages associated with the target document.

In the present disclosure, a plurality of possibilities may exist for specific implementation of determining the comprehensive satisfaction degree based on the satisfaction results corresponding to the question messages associated with the target document. When the specific forms of the satisfaction results corresponding to the question messages are different, the specific implementation methods for determining the comprehensive satisfaction degree may also be different. The present disclosure does not limit a specific implementation method. For purpose of understanding, a plurality of possible situations for determining the comprehensive satisfaction degree are explained below in combination with a plurality of possible forms of satisfaction results.

In one possible scenario, the satisfaction result corresponding to the question messages may be classified as satisfactory or unsatisfactory. For a target document, the proportion of the question messages with satisfaction results in the at least one question message associated with the target document may be counted. The proportion may be used to determine the comprehensive satisfaction degree corresponding to the target document.

In another possible scenario, the satisfaction result corresponding to the question message is a satisfaction grade used to represent the satisfaction degree. For a target document, the average value of the satisfaction grades corresponding to the at least one question message associated with the target document may be calculated. The calculated average value may be determined as the comprehensive satisfaction degree.

In another possible scenario, the satisfaction result corresponding to the question messages is a satisfaction level. For a target document, based on the correspondence relationship between the satisfaction level and the satisfaction grade, the satisfaction level corresponding to each question message associated with the target document may be converted into the satisfaction grade corresponding to the question message. As such, an average value of the satisfaction grades corresponding to the at least one question message associated with the target document may be calculated, and the calculated average value may be determined as the comprehensive satisfaction degree.

There may exist other possibilities for specific forms of the satisfaction results of the question messages. Correspondingly, there may be other possible specific implementations of determining the comprehensive satisfaction degree corresponding to the target document. The present disclosure does not limit a specific implementation method.

S104: when the comprehensive satisfaction degree corresponding to the target document exceeds a set threshold, compressing the target document. The threshold value may be set according to application needs, and is not limited by the present disclosure.

It may be understood that, the comprehensive satisfaction degree corresponding to the target document reflects the user's overall satisfaction with the feedback message output by the task processing model for processing each question message associated with the target document. Since the task processing model processes each question message without relying on the knowledge base, when the comprehensive satisfaction degree corresponding to the target document is high, it means that the task processing model may output the feedback message corresponding to the question message associated with the target document accurately, even without relying on the knowledge objects related to the target document in the knowledge base.

As such, when the comprehensive satisfaction degree of the target document is high, the knowledge information contained in the target document may be little helpful for the task processing model to process the question messages. That is, the knowledge information contained in the target document may have little impact on the accurate processing of the task processing model on the question message. This means that the existence of knowledge objects related to the target document in the knowledge base is little meaningful. Based on this, to reduce the amount of data in the knowledge base and reduce the amount of data in the knowledge base that needs to be loaded when the task processing model processes question messages, the knowledge base updating method may compress target documents whose corresponding comprehensive satisfaction degrees exceed a set threshold.

The purpose of compressing the target document is to reduce the knowledge objects related to the target document in the knowledge base. The compression process for the target document may be to compress the document fragments in the knowledge base belonging to the target document. For example, the document fragments segmented from the target document in the knowledge base, may be partially or completely removed.

In the present disclosure, the knowledge base updating method may respectively determine the target documents in the knowledge base matching each question message to be processed by the task processing model. For each target document, the knowledge base updating method may determine the comprehensive satisfaction degree corresponding to the target document. The comprehensive satisfaction degree corresponding to the target document reflects the user's overall satisfaction with the feedback messages output by the task processing model for processing each question message associated with the target document. Since the task processing model processes each question message without relying on the knowledge base, when the comprehensive satisfaction degree corresponding to the target document is high, it means that the task processing model may output the feedback message corresponding to the question message associated with the target document accurately, even without relying on the knowledge objects related to the target document in the knowledge base. This naturally means that the knowledge information contained in the target document may have little impact on the accurate processing of the task processing model on the question messages. Based on this, by compressing the target document whose corresponding comprehensive satisfaction exceeds a set threshold, the knowledge objects in the knowledge base that have little impact on the task processing model may be reduced. As such, the amount of knowledge information loaded into the memory during the operation of the task processing model may be reduced, and memory resource consumption may thus be reduced. Accordingly, the situation where the task processing model may not be effectively used to process question messages due to insufficient memory resources of the electronic device may be reduced.

It may be understood that, when the amount of question messages associated with the target document is small, the satisfaction results corresponding to the question messages associated with the target document may not accurately reflect the influence of the target document on the task processing model in processing the question messages.

Based on this, the knowledge base updating method may also determine a total amount of question messages associated with the target document. Only when the total amount is greater than a set number and the comprehensive satisfaction degree corresponding to the target document exceeds the set threshold, the target document may be compressed.

In the present disclosure, there may be a plurality of possible specific forms of the knowledge objects in the knowledge base. For example, in one possible scenario, the knowledge base may include a document base. The document base may include a plurality of document fragments, and each document fragment may serve as a knowledge object.

In another possible scenario, to improve the data processing speed of electronic devices, a vector form is generally used in electronic devices to represent data. As such, the knowledge objects in the knowledge base may also represent the vectors of document fragments. For example, the knowledge base may include a vector base, and the vector base may include vectors of different document fragments. Each vector is a vector representation of a document fragment. Each vector may be regarded as a knowledge object. Accordingly, a knowledge object may also represent a document fragment. In one embodiment, the knowledge base may include a document base and a vector base simultaneously. The present disclosure does not limit whether the knowledge base includes a document base and a vector base simultaneously.

In the present disclosure, compressing the target document may include at least one of the followings: compressing the vectors related to the target document in the vector base; and compressing the document fragments related to the target document in the document base.

It is understandable that, with a vector based on a document fragment, it may be efficiently determined whether the document fragment matches the question message. The knowledge base updating method may determine the target document matching the question message based on the vector of each document fragment in the vector base. A possible implementation example is given below for description.

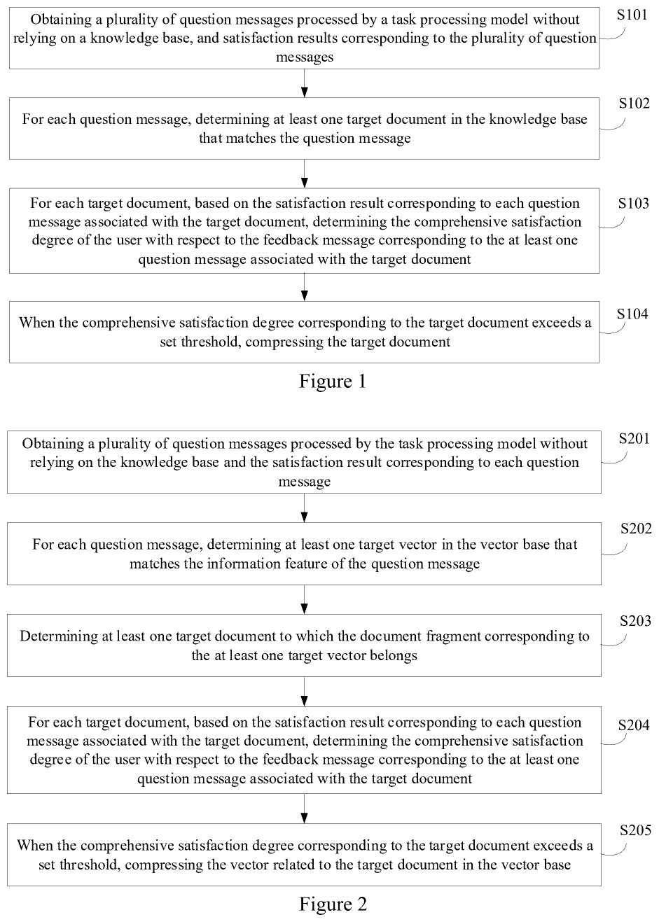

FIG. 2 illustrates another flow chart of a knowledge base updating method

consistent with the disclosed embodiments of the present disclosure. As shown in FIG. 2, in one embodiment, the knowledge base updating method may include: S201, S202, S203, S204 and S205.

S201: obtaining a plurality of question messages processed by the task processing model without relying on the knowledge base and the satisfaction result corresponding to each question message. The satisfaction result corresponding to the question message indicates the user's satisfaction with the feedback message output by the task processing model in processing the question message.

In one embodiment, for ease of understanding, a knowledge base including a document base and a vector base is taken as an example. The document base includes at least one document fragment segmented from at least one document. The vector base includes the vector of each document fragment in the document base.

S202: for each question message, determining at least one target vector in the vector base that matches the information feature of the question message.

The information feature of the question message is the information feature extracted and used to characterize the feature information of the question message. For example, the question message may be vector-encoded to obtain a feature vector for representing the question message.

The target vector that matches the information feature of the question message may be a vector whose similarity with the information feature of the question messages is less than a set matching threshold. For example, the information feature of the question messages is the feature vector of the question messages. The spacing between the feature vector of the question message and each vector in the vector base may be calculated. The vector whose spacing to the feature vector of the question messages is less than a set matching threshold may be determined as a target vector.

S203: determining at least one target document to which the document fragment corresponding to the at least one target vector belongs. For example, based on the mapping relationship between the document fragments in the document base and the vectors in the vector base, the document fragment represented by the target vector may be determined. Then, based on the metadata recorded in the document base, the target document to which the document fragment represented by the target vector belongs may be queried.

In one embodiment, by matching the vector of each document fragment in the vector base with the information feature of the question message, the document fragment represented by the vector matching the question message may be determined efficiently and accurately. It should be noted that, the above description is based on an example that, when updating the knowledge base, the at least one target document that matches each question message is determined in real time.

In practical applications, to improve the efficiency of knowledge base updating, before updating the knowledge base, each time after the question message is obtained, the at least one target document matching the question message may be determined. However, the at least one target document may be determined still by using the approaches of S202 and step S203, which will not be elaborated here.

S204: for each target document, based on the satisfaction result corresponding to each question message associated with the target document, determining the comprehensive satisfaction degree of the user with respect to the feedback message corresponding to the at least one question message associated with the target document. For this operation, reference may be made to the above descriptions, and the present disclosure does not have a specific limitation for this operation.

S205: when the comprehensive satisfaction degree corresponding to the target document exceeds a set threshold, compressing the vector related to the target document in the vector base. For example, part of or each of the vectors related to the target document may be removed from the vector base.

In most application scenarios, to improve the efficiency of the task processing model in processing the question message, the task processing model may use the vectors of document fragments to perform knowledge retrieval. As such, when the task processing model uses the knowledge base to process the question message, the knowledge base loaded into the memory in most scenarios may be a vector base containing the vectors corresponding to each document fragment. Accordingly, to reduce the amount of knowledge base data loaded into memory, the vectors in the vector base need to be compressed. The above description is based on an example of compressing vectors in the vector base.

It is understandable that, during the process of processing the question information, when the task processing model performs knowledge retrieval with the help of a document base, the document fragments related to the target document in the document base may be compressed.

In one embodiment, to keep the one-to-one mapping relationship between the documents in the document base and the vectors in the vector base, while compressing the vectors related to the target document in the vector base, the document fragments related to the target document in the document base may be compressed.

As will be described below, there may be a plurality of possible implementations for compressing the knowledge base based, on the target document.

In one embodiment, for each target document, when the comprehensive satisfaction degree corresponding to the target document exceeds a set threshold, at least one target knowledge object in the knowledge base that is associated with the target document and whose importance level meets requirements may be determined. Each knowledge object in the knowledge base that is associated with the target document and does not belong to the target knowledge object may be removed.

For example, each of the vectors in the vector base that are associated with the target document and whose importance does not meet the requirements may be removed. For another example, each of the documents in the document base that are associated with the target document and whose importance degree does not meet the requirements may be removed.

In the above two examples, the requirements of importance degree may be set according to application needs. For example, the target knowledge object that meets the requirements of importance degree may be at least one target document fragment or vector of the target document fragment in the target document that may represent the subject meaning of the target document. For another example, the target knowledge object that meets the requirements of importance degree may be a representative target knowledge object in the knowledge objects associated with the target document.

To determine the representative target knowledge object, in an optional approach, the knowledge base updating method may cluster the vectors of each document fragment associated with the target document in the knowledge base, and determine a target vector of at least one target document segment as the cluster center. Accordingly, each knowledge object in the knowledge base that is associated with the target document and does not belong to the target vector or the target document fragment represented by the target vector, may be removed.

For example, the knowledge base may include at least one of a document base and a vector base. For the document base, each document associated with the target document and not belonging to the target document fragment may be removed. For the vector base, each vector associated with the target document and not belonging to the target vector may be removed.

In another possible approach, when the comprehensive satisfaction degree corresponding to the target document exceeds a set threshold, each knowledge object associated with the target document in the knowledge base may be removed. In this approach, each knowledge object associated with the target document in the knowledge base may be deleted or transferred from the knowledge base to other storage areas.

In practical applications, any one of the above two approaches may be selected according to actual needs to compress the knowledge object associated with the target document in the knowledge base.

In addition, considering the different comprehensive satisfaction degrees of the target document, the impact of the target document on the task processing model in processing question messages may also be different. Accordingly, in the present disclosure, different compression processing methods may be used based on specific values of the comprehensive satisfaction degree corresponding to the target document.

For example, when the comprehensive satisfaction degree corresponding to the target document exceeds the first set threshold and is lower than the second set threshold, at least one target knowledge object in the knowledge base that is associated with the target document and meets the requirements of importance degree may be determined. Each knowledge object in the knowledge base that is associated with the target document and does not belong to the target knowledge object may be removed. When the comprehensive satisfaction degree corresponding to the target document is not lower than the second set threshold, each knowledge object associated with the target document in the knowledge base may be removed.

In the present disclosure, based on the plurality of question messages and the satisfaction result of each question message, the operation of updating the knowledge base may be performed when a trigger operation of the user is detected, or may be performed when a specific condition is met.

For example, in one embodiment, when a set knowledge base update time is reached or the data volume of the knowledge base exceeds a set data volume, the plurality of question messages processed by the task processing model without relying on the knowledge base and the satisfaction result corresponding to each question messages may be obtained.

The knowledge base update time may be a knowledge base update time determined according to a set knowledge base update cycle, or may be a knowledge base update time pre-set by a user. The present disclosure does not limit a specific type of knowledge base update time. The data volume may be set according to application needs. For example, the data volume may be set with reference to the memory resources of the electronic device. The present disclosure does not limit a specific approach for setting the data volume.

It is understandable that, before updating the knowledge base, the knowledge base updating method may select part of the question messages input by the user as test question messages as needed. Correspondingly, after obtaining a question message entered by the user, when the question message is selected as a test question message, the knowledge base updating method may use the task processing model to output a feedback message of the question message without relying on the knowledge base, and obtain a satisfaction result, input by the user, of the feedback message of the question message. On this basis, the knowledge base updating method may store the test question message and the satisfaction result corresponding to the question message. As such, when the knowledge base needs to be updated, a plurality of question messages processed by the task processing model without relying on the knowledge base may be obtained.

In addition, when a user uses the task processing model to process question messages, the user may hope that the task processing model may output accurate feedback messages. To reduce the impact of updating the knowledge base on accuracy of the feedback messages output by the task processing model and reduce the impact of question messages used as test question messages on user experience, the knowledge base updating method may instruct the task processing model to re-output feedback messages of the question messages using the knowledge base, when the satisfaction results corresponding to the question messages are unsatisfactory.

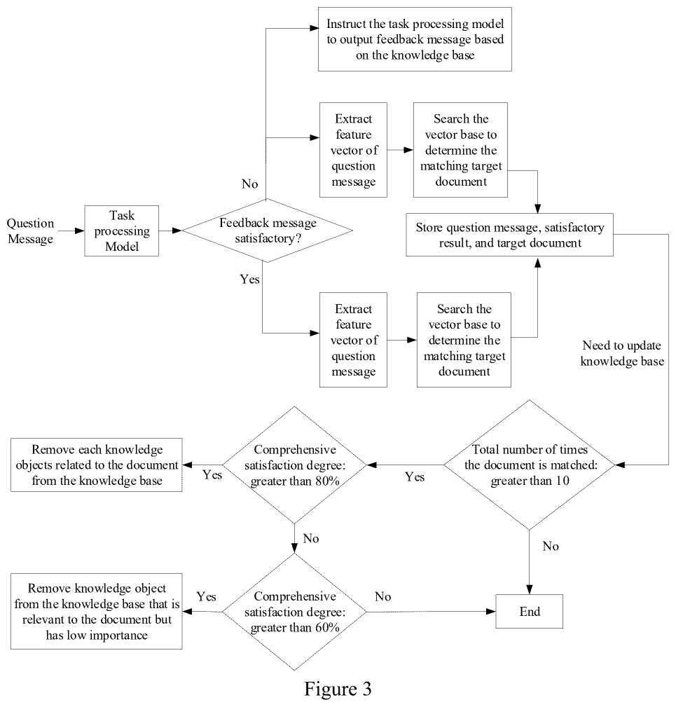

FIG. 3 illustrates a schematic framework of an implementation principle of a knowledge base updating method consistent with the disclosed embodiments of the present disclosure. As shown in FIG. 3, before updating the knowledge base, when a question message is obtained and used as a test question message, after the question message is input into the task processing model, different processing strategies may be adopted depending on whether the user is satisfied with the feedback message output by the task processing model.

Regardless of whether the user is satisfied with the feedback message output by the task processing model, after determining the information feature of the question message, the knowledge base updating method may retrieve the vector base based on the information feature of the question message (such as, a feature vector). Based on the vector retrieved, at least one target document matching the question message may be determined. Then, the satisfaction result corresponding to the question message and the information of the at least one target document matched by the question message may be stored.

When the user is not satisfied with the feedback message output by the task processing model, to avoid affecting the user experience, the knowledge base updating method may use the task processing model to re-output the feedback message of the question message based on the knowledge base.

For example, based on the information feature of the question message, at least one vector in the vector base that matches the information feature of the question message may be determined. The at least one vector may be input into the task processing model as prompt information of the question message, such that the task processing model may re-output a feedback message based on the question message and the prompt information.

As such, when the knowledge base needs to be updated currently, the total number of times each target document is matched may be counted and the comprehensive satisfaction degree of the corresponding document may be obtained. The total number of times the target document is matched is the total number of times the target document is matched with different question messages, that is, the total number of question messages matching the target document.

Correspondingly, based on the corresponding relationship between the comprehensive satisfaction degree corresponding to the document and different set thresholds, different compression processing methods may be used to compress the knowledge base.

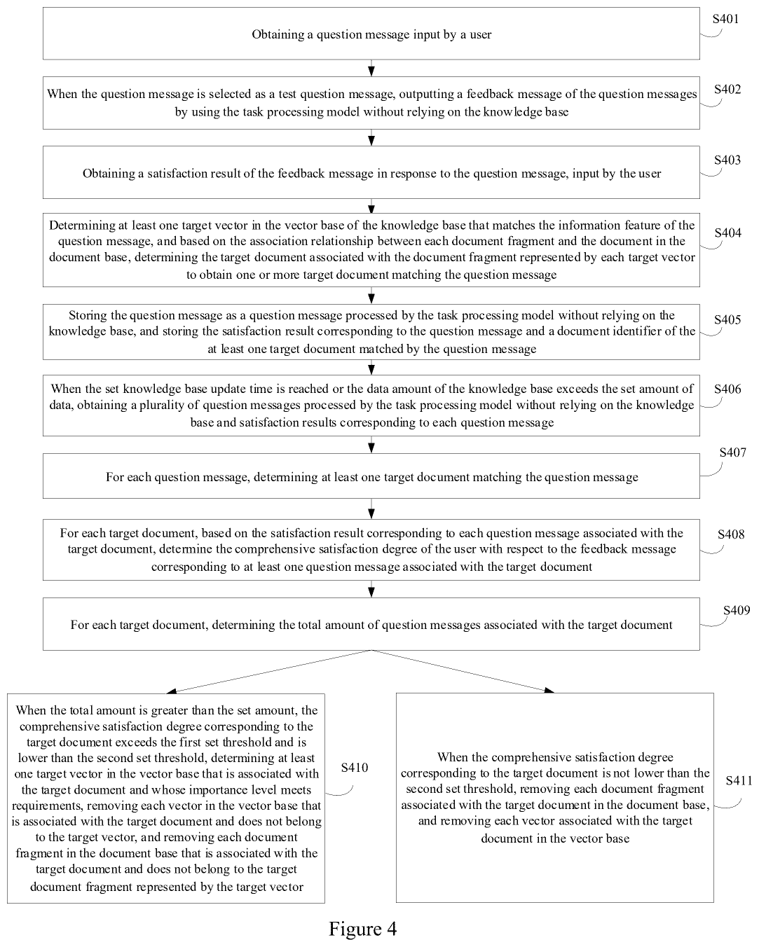

FIG. 4 illustrates another flow chart of a knowledge base updating method consistent with the disclosed embodiments of the present disclosure. As shown in FIG. 4, in one embodiment, the method may include S401-S409, and S410 or S411.

S401: obtaining a question message input by a user.

S402: when the question message is selected as a test question message, outputting a feedback message of the question messages by using the task processing model without relying on the knowledge base.

It is understandable that, to improve the accuracy of the feedback message determined, the task processing model may need to process the question message with the help of the knowledge information provided by the knowledge base. In the present disclosure, to determine the target document that needs to be compressed, for the question message selected for testing, the task processing model may process the question message without relying on the knowledge base.

Whether the question message is used as the test question message may be determined according to a preset selection policy for selecting the question message, which is not limited by the present disclosure. For example, a part of the question messages may be randomly selected as the test question message. Accordingly, when a question message is randomly selected, the question message may be determined to be a test question message.

In one embodiment, the frequency of obtaining the test question messages may be set according to application requirements. When the frequency of obtaining the question messages is reached, the question message obtained may be determined as a test question message. For example, for every set number of question messages, one question message is determined as a test question message. There may be other ways to determine the test question message, and the present disclosure does not limit any specific way for determining the test question message.

S403: obtaining a satisfaction result of the feedback message in response to the question message, input by the user.

S404: determining at least one target vector in the vector base of the knowledge base that matches the information feature of the question message, and based on the association relationship between each document fragment and the document in the document base, determining the target document associated with the document fragment represented by each target vector to obtain at least one target document matching the question message. For specific implementation of determining the target vector and determining the target document based on the target vector, reference may be made to FIG. 2 and related descriptions, which will not be elaborated here.

S405: storing the question message as a question message processed by the task processing model without relying on the knowledge base, and storing the satisfaction result corresponding to the question message and a document identifier of the at least one target document matched by the question message. The document identifier of the target document may be a document name, a document code or other identification information of the target document, which is not limited by the present disclosure.

The above description takes determining the target document matching the question message when obtaining the test question message as an example. It should be noted that, determining the target document matching the question message may also be performed in a subsequent process of updating the knowledge base. For details, reference may be made to previous embodiments, which will not be elaborated here.

In particular, as shown in FIG. 3, when the satisfaction result corresponding to the question message is unsatisfactory, the knowledge base updating method may instruct the task processing model to utilize the knowledge base (such as the vector base) to re-output a feedback message for the question message.

It should be noted that, operations of S401-S405 are preparations before updating the knowledge base, and are not operations that need to be performed every time when a knowledge base is updated. Just for ease of understanding, in the present disclosure, the process of obtaining question messages and the corresponding satisfaction results is described above.

S406: when the set knowledge base update time is reached or the data amount of the knowledge base exceeds the set amount of data, obtaining a plurality of question messages processed by the task processing model without relying on the knowledge base and satisfaction results corresponding to each question message.

S407: for each question message, determining at least one target document matching the question message. For example, based on the corresponding relationship between the stored question message and the document identifier of at least one target document, at least one target document matching the question message may be determined. It may be understood that each target document may be matched with one or more question messages, and thus, each target document may be associated with at least one question message.

S408: for each target document, based on the satisfaction result corresponding to each question message associated with the target document, determine the comprehensive satisfaction degree of the user with respect to the feedback message corresponding to at least one question message associated with the target document. For details, reference may be made to related descriptions in the present disclosure, which will not be elaborated here.

S409: for each target document, determining the total amount of question messages associated with the target document. The total number of question messages associated with the target document is the total number of times the target document is matched with question messages.

S410: for each target document, when the total amount is greater than the set amount, the comprehensive satisfaction degree corresponding to the target document exceeds the first set threshold and is lower than the second set threshold, determining at least one target vector in the vector base that is associated with the target document and whose importance level meets requirements, removing each vector in the vector base that is associated with the target document and does not belong to the target vector, and removing each document fragment in the document base that is associated with the target document and does not belong to the target document fragment represented by the target vector.

As shown in FIG. 3, in one example, the times (equivalent to the quantity) is set as 10. When the total times the target document is matched is not greater than 10, there is no need to compress the vector and document fragment associated with the target document. Only when the total times the target document is matched is greater than 10, the knowledge base updating method may further determine the threshold range satisfied by the comprehensive satisfaction degree of the target document, and performs different compression processes.

As shown FIG. 3, in one embodiment, the first threshold value is set to be 60% and the second threshold value is set to be 80%. When the comprehensive satisfaction degree corresponding to the target document is greater than 60% but less than 80%, the target document may still have some influence on the task processing model in processing the question messages. In this case, it may be inappropriate to remove each of the vectors and document fragments associated with the target document. As such, the knowledge base updating method may only remove vectors and document fragments that are associated with the target document and have relatively low importance.

For determining the target vector whose importance level meets requirements (i.e., the importance is relatively high), reference may be made to clustering the vectors of each document fragment segmented from the target document, as described in the present disclosure, and will not be elaborated here.

S411: for each target document, when the comprehensive satisfaction degree corresponding to the target document is not lower than the second set threshold, removing each document fragment associated with the target document in the document base, and removing each vector associated with the target document in the vector base.

As shown in FIG. 3, in one embodiment, the second threshold is set to be 80%. When the comprehensive satisfaction degree of the target document is not less than 80%, the knowledge information contained in the target document may basically have no effect on the task processing model in processing the question message. Accordingly, each vector and document fragment associated with the target document may be removed to minimize the data amounts of the vector base and document base.

The user of the electronic device may also add a document fragment to the document base according to actual needs. To minimize the invalid data in the knowledge base that has little effect on the task processing model in processing question messages, before adding a document fragment to the knowledge base, the knowledge base updating method may determine whether the document fragment is invalid data that is useless to the task processing model. A document fragment may be added to the knowledge base (e.g., the document base) only when the document fragment is valid data.

FIG. 5 illustrates an implementation flowchart of controlling a document fragment to be added to a knowledge base, consistent with the disclosed embodiments of the present disclosure. In one embodiment, as shown in FIG. 5, the knowledge base updating method may include: S501, S502 and S503.

S501: obtaining at least one pending document fragment to be stored. For example, at least one pending document uploaded by the user may be obtained, and at least one pending document fragment obtained by segmenting the pending document may be obtained. The user may also directly upload at least one pending document fragment associated with different documents, which is limited by the present disclosure.

S502: for each pending document fragment, using a task processing model to generate a test question message for the pending document fragment, and using the task processing model to generate a test feedback message of the test question message without the aid of the pending document fragment, and obtain a test result.

The test question message for the pending document fragment refers to the question message generated by the task processing model using the pending document fragment. The question message is a non-universal question message related to the pending document fragment. Correspondingly, the feedback message corresponding to the test question message may also be related to the content of the pending document fragment.

The test result may indicate the generation status of the test question message and the test feedback message of the pending document fragment. For example, the test result may indicate whether the task processing model generates the test question message for the pending document fragment. The test result may also indicate, under the premise that the task processing model generates the test question message of the pending document fragment, whether the task processing model may generate a feedback message of the test question message without the help of the pending document fragment. For the sake of distinction, the feedback message output by the task processing model in response to the test question message is referred to as a test feedback message.

S503: when the test result indicates that the task processing model may generate the test question message of the pending document fragment and the task processing model may not generate the test feedback message of the test question message without the pending document fragment, adding at least one of the pending document fragment and the test feedback message corresponding to the pending document fragment to the knowledge base.

It is understandable that, when the task processing model may not generate the test question message using the pending document fragment, the pending document fragment may not provide knowledge basis for processing the question message. As such, the information in the pending document fragment is invalid information that is irrelevant to the question message that may be processed by the task processing model. For example, the pending document fragment may be directory information or other information that does not contain valid knowledge content. Accordingly, when the task processing model may not generate a test question message using the pending document fragment, to avoid storing invalid data in the knowledge base and increasing the data volume, the pending document fragment may not be added to the knowledge base.

Similarly, when the task processing model may generate a test question message using the pending document fragment, but the task processing model may also generate a test feedback message for the test question message without the pending document fragment, it means that similar knowledge may already be included in the knowledge base. Even if the pending document fragment is not used, there will be no impact on determining the feedback message for the test question message. Accordingly, the pending document fragment may not be added to the knowledge base.

As such, for each pending document fragment, when the test result indicates that the task processing model may not generate a test question message of the pending document fragment, or, the task processing model may generate a test question message for the pending document fragment and the task processing model may generate the test feedback message for the test question message without the aid of the pending document fragment, the pending document fragment may not be added to the knowledge base.

Correspondingly, when the task processing model may generate a test question message of the pending document fragment and the task processing model may not generate a test feedback message for the test question message without the pending document fragment, the pending document fragment is valid information that is useful to the task processing model, and the pending document fragment may be added to the knowledge base.

When the knowledge base includes a document base, the knowledge base

updating method may add the pending document fragment to the document base. When the knowledge base also includes a vector base, while or after the pending document fragment is added to the document base, a vector corresponding to the pending document fragment may be generated and added to the vector base.

In the present disclosure, there may be a plurality of possibilities for specific implementation of obtaining the test result by using the task processing model. In one embodiment, the task processing model may be controlled to generate a test question message and generate a test feedback message for the test question message, in a step-by-step way.

Specifically, first, for each pending document fragment, the task processing model may be instructed to generate a test question message for the pending document fragment, and obtain a question generation result of the task processing model. The question generation result may be used to indicate whether the task processing model may successfully generate the test question message. For example, a task processing program may be operated in an electronic device. The task processing model may be configured in the task processing program. The task processing program may input the pending document fragment into the task processing model, and instruct the task processing model to generate a test question message for the pending document fragment.

Secondly, when the question generation result indicates that the task processing model may generate the test question message, the task processing model may be instructed to generate a test feedback message of the test question message without the aid of the pending document fragment, and obtain a feedback generation result. The feedback generation result may be used to indicate whether the task processing model may generate the test feedback message for the test question message.

Correspondingly, when the question generation result corresponding to the pending document fragment indicates that the task processing model may generate the test question message for the pending document fragment, and the feedback generation result indicates that the task processing model may not generate the test feedback message for the test question message without the pending document fragment, the pending document fragment may be added to the knowledge base.

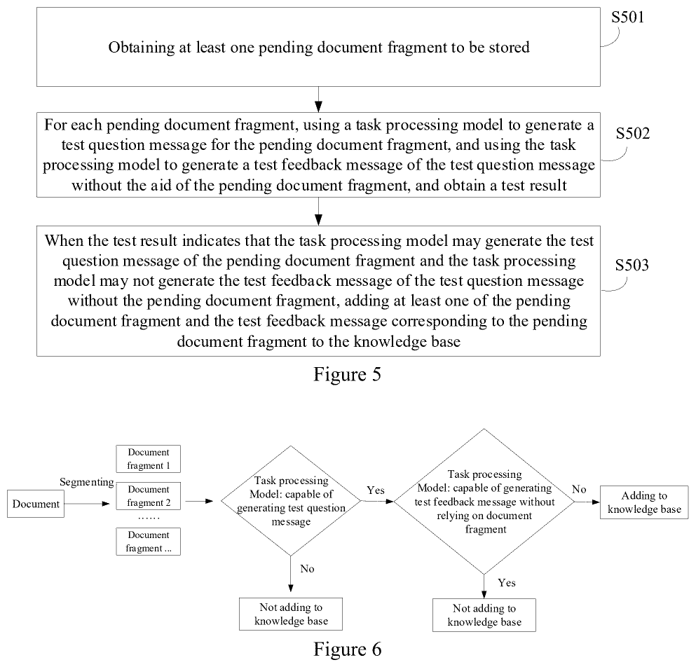

FIG. 6 illustrates a schematic framework of an implementation principle for controlling a document fragment to be added to a knowledge base, consistent with the disclosed embodiments of the present disclosure. To understand the process of controlling a document fragment to be added to the knowledge base, reference may be made to FIG. 6.

FIG. 6 takes the example that the pending document fragments are obtained by segmenting a document uploaded by a user. As shown in FIG. 6, after obtaining the document uploaded by the user, the document may be segmented into at least one document fragment. For each document fragment, the knowledge base updating method may use the task processing model to generate a test question message for the document fragment. When the task processing model may not generate the test question message for the document fragment, the document fragment may not be added to the knowledge base.

On the premise that the task processing model may generate a test question messages, the task processing model may be required to generate a test feedback message for the test question message without the aid of the pending document fragment. When the test feedback message may be generated, the document fragment may not be added to the knowledge base. On the contrary, when the task processing model may not generate a test feedback message to obtain a feedback generation result, the document fragment may be added to the knowledge base.

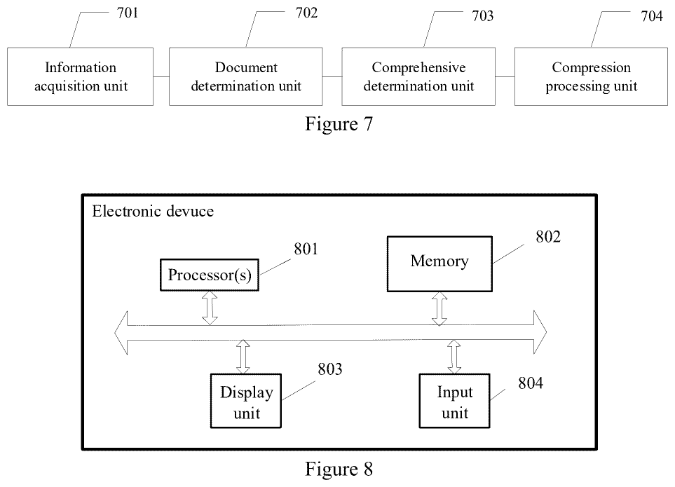

The present disclosure also provides a knowledge base updating device. FIG. 7 illustrates a schematic composition structural diagram of a knowledge base updating device consistent with the disclosed embodiments of the present disclosure. As shown in FIG. 7, in one embodiment, the knowledge base updating device may include an information acquisition unit 701, a document determination unit 702, a comprehensive determination unit 703, and a compression processing unit 704.

The information acquisition unit 701 is configured to obtain a plurality of question messages processed by the task processing model without relying on the knowledge base and the satisfaction results corresponding to the question messages. The satisfaction results may be used to indicate the user's satisfaction degree with the feedback messages output by the task processing model in processing the question messages.

The document determination unit 702 is configured to determine at least one target document in the knowledge base that matches the question message.

The comprehensive determination unit 703 is configured to determine a comprehensive satisfaction degree of the user with respect to feedback message corresponding to the at least one question message associated with the target document based on the satisfaction results corresponding to each question message associated with the target document.

The compression processing unit 704 is configured to compress the target document when the comprehensive satisfaction degree corresponding to the target document exceeds a set threshold.

In one embodiment, the knowledge base includes a document base and a vector base. The document base includes at least one document fragment obtained by segmenting at least one document. The vector base includes the vector of each document fragment in the document base.

The document determination unit includes a vector determination subunit and a document determination subunit. The vector determination subunit is configured to determine at least one target vector in the vector base that matches the information feature of the question message. The document determination subunit is configured to determine at least one target document to which the document fragment corresponding to the at least one target vector belongs.

The compression processing unit is configured for compressing the target document, including at least one of the followings: compressing the vectors in the vector base that are related to the target document; and compressing the document fragments related to the target document in the document base.

In another embodiment, the compression processing unit includes at least one of a first compression processing subunit, or a second compression processing subunit.

The first compression processing subunit is configured to, when the comprehensive satisfaction degree corresponding to the target document exceeds a set threshold, determine at least one target knowledge object in the knowledge base that is associated with the target document and whose importance level meets the requirements, and remove each knowledge object in the knowledge base that is associated with the target document and does not belong to the target knowledge object.

The second compression processing subunit is configured to, when the comprehensive satisfaction degree corresponding to the target document exceeds a set threshold, remove each knowledge object associated with the target document in the knowledge base. The knowledge object represents at least one of a document fragment and a vector of the document fragment.

In another embodiment, the first compression processing subunit is specifically configured to, when the comprehensive satisfaction degree corresponding to the target document exceeds a first set threshold and is lower than a second set threshold, determine at least one target knowledge object in the knowledge base that is associated with the target document and whose importance level meets requirements, and remove each knowledge object in the knowledge base that is associated with the target document and does not belong to the target knowledge object.

The second compression processing subunit is specifically configured to, when the comprehensive satisfaction degree corresponding to the target document is not lower than a second set threshold, remove each knowledge object associated with the target document in the knowledge base.

In another embodiment, the first compression processing subunit is specifically configured to, when determining at least one target knowledge object in the knowledge base that is associated with the target document and whose importance level meets the requirements, cluster the vector of each document fragment associated with the target document in the knowledge base, and determine a target vector of at least one target document fragment as a cluster center.

When removing the knowledge object in the knowledge base that is associated with the target document and does not belong to the target knowledge object, the first compression processing subunit is specifically configured to remove the knowledge object in the knowledge base that is associated with the target document and does not belong to the target document fragment or the target vector.

In another embodiment, the knowledge base updating device also includes a quantity determination unit, configured to determine a total quantity of question messages associated with the target document. The compression processing unit is specifically configured to, when the total quantity is greater than a set number and the comprehensive satisfaction degree corresponding to the target document exceeds a set threshold, compress the target document.

In another embodiment, the knowledge base updating device also includes: a question acquisition unit, a feedback output unit, a satisfaction result acquisition unit, an information storage unit, a feedback re-output unit, and an information acquisition unit.

The question acquisition unit is configured to obtain a question message input by a user.

The feedback output unit is configured to, when it is confirmed that the question message is selected as a test question message, output a feedback message of the question message by using a task processing model without relying on a knowledge base.

The satisfaction result acquisition unit is configured to obtain a satisfaction result input by the user for the feedback message of the question message.

The information storage unit is configured to store the question message as a question message processed by the task processing model without relying on the knowledge base, and store a satisfaction result corresponding to the question message.

The feedback re-output unit is configured to instruct the task processing model to re-output the feedback message of the question messages using the knowledge base when the satisfaction result corresponding to the question message is unsatisfactory.

The information acquisition unit is configured to, when the set knowledge base update time is reached or the data volume of the knowledge base exceeds the set data volume, obtain a plurality of question messages processed by the task processing model without relying on the knowledge base and satisfaction results corresponding to the question messages.

In another embodiment, the knowledge base updating device also includes a fragment acquisition unit, a test processing unit, and a document storage unit.

The fragment acquisition unit is configured to obtain at least one pending document fragment to be stored.

The test processing unit is configured to generate a test question message for the pending document fragment using the task processing model, and generate a test feedback message of the test question messages by using the task processing model without using the pending document fragment to obtain a test result. The test result may indicate the generation status of the test question message and the test feedback message of the pending document fragment.

The document storage unit is configured to, when the test result shows that the task processing model may generate the test question message for the pending document fragment and the task processing model may not generate the test feedback message for the test question message without the help of the pending document fragment, add at least one of the pending document fragment and the test feedback message corresponding to the pending document fragment to the knowledge base.

In addition, the knowledge base updating device may also include a non-entry control unit. The non-entry control unit is configured to, when the test result indicates that the task processing model may generate the test question message for the pending document fragment, and the task processing model may generate the test feedback message for the test question message without the aid of the pending document fragment, or the task processing model may not generate the test question message for the pending document fragment, keep the knowledge base from adding the pending document fragment.

The present disclosure also provides an electronic device. FIG. 8 illustrates a schematic composition structural diagram of an electronic device consistent with the disclosed embodiments of the present disclosure. The electronic device may be any type of electronic device. As shown in FIG. 8, the electronic device at least includes a processor 801 and a memory 802. The processor 801 is configured to execute the knowledge base updating method provided by the present disclosure. The memory 802 is configured to store a program required by the processor to perform operations.

It is understandable that the electronic device may also include a display unit 803 and an input unit 804. The electronic device may have more or fewer components than the figuration shown in FIG. 8. The present disclosure does not limit whether the electronic device has more or fewer components than the figuration shown in FIG. 8.

The present disclosure also provides a computer-readable storage medium. The computer-readable storage medium may be stored with at least one instruction, at least one program, a code set or an instruction set. The at least one instruction, the at least one program, the code set or the instruction set may be loaded and executed by the processor to implement the knowledge base updating method provided by the present disclosure.

The present disclosure also proposes a computer program. The computer program includes computer instructions. The computer instructions may be stored in a computer-readable storage medium. When the computer program is run on an electronic device, the computer program may be used to execute the knowledge base updating method provided by the present disclosure.

As disclosed, the technical solutions of the present disclosure have the following advantages.

The knowledge base updating method provided by the present disclosure may respectively determine the target documents in the knowledge base matching each question message to be processed by the task processing model. For each target document, the knowledge base updating method may determine the comprehensive satisfaction degree corresponding to the target document. The comprehensive satisfaction degree corresponding to the target document reflects the user's overall satisfaction with the feedback messages output by the task processing model for processing each question message associated with the target document. Since the task processing model processes each question message without relying on the knowledge base, when the comprehensive satisfaction degree corresponding to the target document is high, it means that the task processing model may output the feedback message corresponding to the question message associated with the target document accurately, even without relying on the knowledge objects related to the target document in the knowledge base. This naturally means that the knowledge information contained in the target document may have little impact on the accurate processing of the task processing model on the question messages. Based on this, by compressing the target document whose corresponding comprehensive satisfaction exceeds a set threshold, the knowledge objects in the knowledge base that have little impact on the task processing model may be reduced. As such, the amount of knowledge information loaded into the memory during the operation of the task processing model may be reduced, and memory resource consumption may thus be reduced. Accordingly, the situation where the task processing model may not be effectively used to process question messages due to insufficient memory resources of the electronic device may be reduced

The embodiments disclosed in the present disclosure are exemplary only and not limiting the scope of the present disclosure. Various combinations, alternations, modifications, or equivalents to the technical solutions of the disclosed embodiments may be obvious to those skilled in the art and may be included in the present disclosure. Without departing from the spirit of the present disclosure, the technical solutions of the knowledge base updating method may be implemented by other embodiments, and such other embodiments are intended to be encompassed within the scope of the present disclosure.

What is claimed is:

1. A knowledge base updating method, comprising:
obtaining a plurality of question messages processed by a task processing model without relying on a knowledge base and a plurality of satisfaction results corresponding to the plurality of question messages, wherein a satisfaction result of the plurality of satisfaction results corresponding to a question message of the plurality of question messages indicates a satisfaction degree of a user with a feedback message output by the task processing model in processing the question message;
determining at least one target document in the knowledge base matching a question message of the plurality of question messages;
based on a satisfaction result of the plurality of satisfaction results corresponding to each question message of at least one question message of the plurality of question messages associated with a target document of the at least one target document, determining a comprehensive satisfaction degree of the user with at least one feedback message corresponding to the at least one question message associated with the target document; and
when the comprehensive satisfaction degree corresponding to the target document exceeds a set threshold, compressing the target document.

2. The method according to claim 1, wherein:
the knowledge base includes a document base and a vector base, wherein the document base includes at least one document fragment obtained by segmenting at least one document, and the vector base includes a vector of each document fragment of the at least one document fragment in the document base;
determining the at least one target document in the knowledge base matching the question message of the plurality of question messages includes: determining at least one target vector in the vector base matching an information feature of the question message; and determining the at least one target document, to which a document fragment of the at least one document fragment corresponding to the at least one target vector belongs; and
compressing the target document includes at least one of operations including: compressing a vector in the vector base related to the target document; or compressing a document fragment related to the target document in the document base.

3. The method according to claim 1, wherein compressing the target document includes:
when the comprehensive satisfaction degree corresponding to the target document exceeds the set threshold:
determining at least one target knowledge object in the knowledge base that is associated with the target document and whose importance level meets a requirement, and removing each knowledge object in the knowledge base that is associated with the target document and does not belong to the at least one target knowledge object; or
removing each knowledge object associated with the target document in the knowledge base,
wherein the knowledge object represents at least one of: a document fragment of the at least one document fragment in the document base, or a vector of the document fragment.

4. The method according to claim 3, wherein:
determining the at least one target knowledge object and removing each knowledge object in the knowledge base include:
when the comprehensive satisfaction degree corresponding to the target document exceeds a first set threshold and is lower than a second set threshold, determining at least one target knowledge object in the knowledge base that is associated with the target document and whose importance level meets the requirement, and removing each knowledge object in the knowledge base that is associated with the target document and does not belong to the at least one target knowledge object; or
removing each knowledge object associated with the target document in the knowledge base includes:
when the comprehensive satisfaction degree corresponding to the target document is not lower than the second set threshold, removing each knowledge object associated with the target document in the knowledge base.

5. The method according to claim 3, wherein:
determining the at least one target knowledge object in the knowledge base that is associated with the target document and whose importance level meets the requirement includes:
clustering a vector of each document fragment associated with the target document in the knowledge base, forming a vector cluster; and determining a target vector of at least one target document fragment at a center of the vector cluster; and
removing each knowledge object in the knowledge base that is associated with the target document and does not belong to the at least one target knowledge object includes:
removing the knowledge object in the knowledge base that is associated with the target document and does not belong to the at least one target document fragment or the target vector.

6. The method according to claim 1, further comprising determining a total quantity of the question messages associated with the target document, wherein:
when the comprehensive satisfaction degree corresponding to the target document exceeds the set threshold, compressing the target document includes:
when the total quantity of the question messages associated with the target document is greater than a set quantity, and the comprehensive satisfaction degree corresponding to the target document exceeds the set threshold, compressing the target document.

7. The method according to claim 1, further comprising:
obtaining a question message input by the user;
when the question message is selected as a test question message, outputting a feedback message of the question message by using the task processing model without relying on the knowledge base;
obtaining a satisfaction result input by the user for the feedback message of the question message;
storing the question message as a question message processed by the task processing model without relying on the knowledge base, and storing the satisfaction result corresponding to the question message; and
instructing the task processing model to re-output a feedback message of the question message relying on the knowledge base when the satisfaction result corresponding to the question message is unsatisfactory,
wherein:
obtaining the plurality of question messages processed by the task processing model without relying on the knowledge base, includes:
when a time set for updating the knowledge base is reached or a data volume of the knowledge base exceeds a set data volume, obtaining the plurality of question messages processed by the task processing model without relying on the knowledge base, the plurality of satisfaction results corresponding to the plurality of question messages.

8. The method according to claim 1, further comprising:
obtaining at least one pending document fragment to be stored;
generating a test question message for a pending document fragment of the at least one pending document fragment using the task processing model, and generating a test feedback message of the test question message by using the task processing model without relying on the pending document fragment, to obtain a test result, wherein the test result indicates generation status of the test question message and the test feedback message of the pending document fragment; and
when the test result indicates that the task processing model is capable of generating the test question message for the pending document fragment and the task processing model is incapable of generating the test feedback message for the test question message without relying on the pending document fragment, adding at least one of the pending document fragment and the test feedback message corresponding to the pending document fragment to the knowledge base.

9. The method according to claim 8, further comprising:
when the test result indicates that the task processing model is capable of generating the test question message for the pending document fragment, and capable of generating the test feedback message for the test question message without relying on the pending document fragment, or the task processing model is incapable of generating the test question message for the pending document fragment, keeping the pending document fragment from being added to the knowledge base.

10. An electronic device, comprising:
one or more processors and a memory containing a computer program that, when being executed, causes the one or more processors to perform:
obtaining a plurality of question messages processed by a task processing model without relying on a knowledge base and a plurality of satisfaction results corresponding to the plurality of question messages, wherein a satisfaction result of the plurality of satisfaction results corresponding to a question message of the plurality of question messages indicates a satisfaction degree of a user with a feedback message output by the task processing model in processing the question message;
determining at least one target document in the knowledge base matching a question message of the plurality of question messages;
based on a satisfaction result of the plurality of satisfaction results corresponding to each question message of at least one question message of the plurality of question messages associated with a target document of the at least one target document, determining a comprehensive satisfaction degree of the user with at least one feedback message corresponding to the at least one question message associated with the target document; and
when the comprehensive satisfaction degree corresponding to the target document exceeds a set threshold, compressing the target document.

11. The device according to claim 10, wherein:
the knowledge base includes a document base and a vector base, wherein the document base includes at least one document fragment obtained by segmenting at least one document, and the vector base includes a vector of each document fragment of the at least one document fragment in the document base;
the one or more processors are further configured to perform: determining at least one target vector in the vector base matching an information feature of the question message; and determining the at least one target document, to which a document fragment of the at least one document fragment corresponding to the at least one target vector belongs; and
the one or more processors are further configured to perform at least one of operations including: compressing a vector in the vector base related to the target document; or compressing a document fragment related to the target document in the document base.

12. The device according to claim 10, wherein the one or more processors are further configured to perform:
when the comprehensive satisfaction degree corresponding to the target document exceeds the set threshold:
determining at least one target knowledge object in the knowledge base that is associated with the target document and whose importance level meets a requirement, and removing each knowledge object in the knowledge base that is associated with the target document and does not belong to the at least one target knowledge object; or
removing each knowledge object associated with the target document in the knowledge base,
wherein the knowledge object represents at least one of: a document fragment of the at least one document fragment in the document base, or a vector of the document fragment.

13. The device according to claim 12, wherein the one or more processors are further configured to perform:
when the comprehensive satisfaction degree corresponding to the target document exceeds a first set threshold and is lower than a second set threshold, determining at least one target knowledge object in the knowledge base that is associated with the target document and whose importance level meets the requirement, and removing each knowledge object in the knowledge base that is associated with the target document and does not belong to the at least one target knowledge object; or
when the comprehensive satisfaction degree corresponding to the target document is not lower than the second set threshold, removing each knowledge object associated with the target document in the knowledge base.

14. The device according to claim 12, wherein the one or more processors are further configured to perform:
clustering a vector of each document fragment associated with the target document in the knowledge base, forming a vector cluster; and determining a target vector of at least one target document fragment at a center of the vector cluster; and
removing the knowledge object in the knowledge base that is associated with the target document and does not belong to the at least one target document fragment or the target vector.

15. The device according to claim 10, wherein the one or more processors are further configured to perform: determining a total quantity of the question messages associated with the target document, wherein:
when the comprehensive satisfaction degree corresponding to the target document exceeds the set threshold, the one or more processors are further configured to perform:
when the total quantity of the question messages associated with the target document is greater than a set quantity, and the comprehensive satisfaction degree corresponding to the target document exceeds the set threshold, compressing the target document.

16. The device according to claim 10, wherein the one or more processors are further configured to perform:
obtaining a question message input by the user;
when the question message is selected as a test question message, outputting a feedback message of the question message by using the task processing model without relying on the knowledge base;
obtaining a satisfaction result input by the user for the feedback message of the question message;
storing the question message as a question message processed by the task processing model without relying on the knowledge base, and storing the satisfaction result corresponding to the question message; and
instructing the task processing model to re-output a feedback message of the question message relying on the knowledge base when the satisfaction result corresponding to the question message is unsatisfactory,
wherein:
for obtaining the plurality of question messages processed by the task processing model without relying on the knowledge base, the one or more processors are further configured to perform:
when a time set for updating the knowledge base is reached or a data volume of the knowledge base exceeds a set data volume, obtaining the plurality of question messages processed by the task processing model without relying on the knowledge base, the plurality of satisfaction results corresponding to the plurality of question messages.

17. The device according to claim 10, wherein the one or more processors are further configured to perform:
obtaining at least one pending document fragment to be stored;
generating a test question message for a pending document fragment of the at least one pending document fragment using the task processing model, and generating a test feedback message of the test question message by using the task processing model without relying on the pending document fragment, to obtain a test result, wherein the test result indicates generation status of the test question message and the test feedback message of the pending document fragment; and
when the test result indicates that the task processing model is capable of generating the test question message for the pending document fragment and the task processing model is incapable of generating the test feedback message for the test question message without relying on the pending document fragment, adding at least one of the pending document fragment and the test feedback message corresponding to the pending document fragment to the knowledge base.

18. The device according to claim 17, wherein the one or more processors are further configured to perform:
when the test result indicates that the task processing model is capable of generating the test question message for the pending document fragment, and capable of generating the test feedback message for the test question message without relying on the pending document fragment, or the task processing model is incapable of generating the test question message for the pending document fragment, keeping the pending document fragment from being added to the knowledge base.

19. A non-transitory computer readable storage medium containing a computer program that, when being executed, causes at least one processor to perform:
obtaining a plurality of question messages processed by a task processing model without relying on a knowledge base and a plurality of satisfaction results corresponding to the plurality of question messages, wherein a satisfaction result of the plurality of satisfaction results corresponding to a question message of the plurality of question messages indicates a satisfaction degree of a user with a feedback message output by the task processing model in processing the question message;
determining at least one target document in the knowledge base matching a question message of the plurality of question messages;
based on a satisfaction result of the plurality of satisfaction results corresponding to each question message of at least one question message of the plurality of question messages associated with a target document of the at least one target document, determining a comprehensive satisfaction degree of the user with at least one feedback message corresponding to the at least one question message associated with the target document; and
when the comprehensive satisfaction degree corresponding to the target document exceeds a set threshold, compressing the target document.

20. The storage medium according to claim 19, wherein:
the knowledge base includes a document base and a vector base, wherein the document base includes at least one document fragment obtained by segmenting at least one document, and the vector base includes a vector of each document fragment of the at least one document fragment in the document base;
the at least one processor is further configured to perform: determining at least one target vector in the vector base matching an information feature of the question message; and determining the at least one target document, to which a document fragment of the at least one document fragment corresponding to the at least one target vector belongs; and
the at least one processor is further configured to perform at least one of operations including: compressing a vector in the vector base related to the target document; or compressing a document fragment related to the target document in the document base.
